(19) United States
(12) Patent Application Publication
(10) Pub. No.: US 2020/0105213 A1
(43) Pub. Date: Apr. 2, 2020

(54) METHOD AND SYSTEM FOR DRIVING DISPLAY PANEL, AND DISPLAY DEVICE

(71) Applicants: HKC CORPORATION LIMITED, Shenzhen, Guangdong (CN); CHONGQING HKC OPTOELECTRONICS TECHNOLOGY CO., LTD., Chongqing (CN)

(72) Inventor: Zhenli Song, Chongqing (CN)

(21) Appl. No.: 16/312,403

(22) PCT Filed: Nov. 9, 2018
(86) PCT No.: PCT/CN2018/114753

§ 371 Date: Dec. 21, 2018

(30) Foreign Application Priority Data
Sep. 30, 2018 (CN) 201811160787.2

(51) Int. Cl. G09G 3/36; G09G 3/3225

(52) U.S. Cl. CPC G09G 3/3648; G09G 2310/0251; G09G 3/3225; G09G 3/3696

(57) ABSTRACT

In a method and system for driving display panel and a display device proposed by the present disclosure, pre-charge time in a scanning signal as output by the scanning line is increased when a pixel voltage of the original pixel cell in the display panel is lower than a lower limit value of a preset threshold voltage range, the pre-charge time in the scanning signal as output by the scanning line is reduced when the pixel voltage is greater than an upper limit value of the preset threshold voltage range.

### CROSS-REFERENCE TO RELATED APPLICATION

This application is the PCT Application No. PCT/CN2018/114753 for entry into US national phase, with an international filing date of Nov. 9, 2018 designating US, now pending, and claims priority to Chinese Patent Application No. 201811160787.2, filed on Sep. 30, 2018, the content of which is incorporated herein by reference in entirety.

### TECHNICAL FIELD

The present disclosure pertains to the field of display technology, and more particularly to a method for driving display panel, a system for driving display panel and a display device.

### BACKGROUND

With the rapid development of display technology, display equipment such as liquid crystal panel, display and the like are continuously developed in the direction of being thinned, large-screen, low power consumption and low cost. As for commonly used display products, drive signals and scanning control signals are usually processed by TCON (Timing Controller) on PCB (Printed Circuit Board), and then are output to a display panel by a source driver IC (Integrated Circuit) and a gate driver IC to implement driving the display panel.

However, a color cast phenomenon in the display panel may be caused due to the fact that one of a red pixel cell, a green pixel cell and a blue pixel cell is darker, and thus an image quality of the display panel is greatly reduced.

### SUMMARY

An object of the present disclosure is to provide a method for driving display panel to solve the technical problem which includes but is not limited to the technical problem that the color cast phenomenon in the display panel may be caused due to the fact that one of the red pixel cell, the green pixel cell and the blue pixel cell is darker, such that the image quality of the display panel is greatly reduced.

In order to solve the aforesaid technical problem, the technical solution to be used by the present disclosure is as follows:

the present disclosure proposes a method for driving display panel, the display panel comprises 3N scanning lines, N is greater than or equal to 1 and N is a positive integer, the method for driving display panel includes:

determining whether a pixel voltage of an original pixel cell in the display panel is within a preset threshold voltage range or not;

determining whether the pixel voltage is lower than a lower limit value of the preset threshold voltage range or greater than an upper limit value of the preset threshold voltage range, when the pixel voltage of the original pixel cell in the display panel exceeds the preset threshold voltage range;

increasing pre-charge time of a scanning signal as output by the scanning line when the pixel voltage is lower than the lower limit value of the preset threshold voltage range;

reducing the pre-charge time of the scanning signal as output by the scanning line when the pixel voltage is greater than the upper limit value of the preset threshold voltage range.

In one embodiment, the original pixel cell is any one of a red pixel cell, a green pixel cell and a blue pixel cell.

In one embodiment, said increasing pre-charging time of a scanning signal as output by the scanning line includes:

increasing a duty cycle of a high-level pulse in the scanning signal.

In one embodiment, said increasing a duty cycle of a high-level pulse in the scanning signal includes:

determining the duty cycle of the high-level pulse according to the pixel voltage of the original pixel cell.

In one embodiment, said increasing pre-charge time of a scanning signal as output by the scanning line includes:

adding a pre-charge pulse before a scanning pulse of the scanning signal.

In one embodiment, the pre-charge pulse is configured to pre-charge the original pixel cell within a preset interval time before the scanning pulse.

In one embodiment, said reducing the pre-charge time of the scanning signal includes:

reducing the duty cycle of the high-level pulse in the scanning signal.

Another purpose of the present disclosure is providing a system for driving display panel, the display panel comprises 3N scanning lines, N is greater than or equal to 1 and N is a positive integer, the system for driving display panel includes:

a determination device configured to determine whether a pixel voltage of an original pixel cell in the display panel is within a preset threshold voltage range, and further determine whether the pixel voltage is lower than a lower limit value of the preset threshold voltage range or greater than an upper limit value of the preset threshold voltage range; and

a signal adjustment device configured to increase pre-charge time of a scanning signal as output by the scanning line when the pixel voltage is lower than the lower limit value of the preset threshold voltage range, and reduce the pre-charge time of the scanning signal as output by the scanning line when the pixel voltage is greater than the upper limit value of the preset threshold voltage range.

In one embodiment, the original pixel cell is any one of a red pixel cell, a green pixel cell and a blue pixel cell.

In one embodiment, the signal adjustment device is further configured to increase a duty cycle of a high-level pulse in the scanning signal when the pixel voltage is lower than the lower limit value of the preset threshold voltage range.

In one embodiment, the signal adjustment device is further configured to determine the duty cycle of the high-level pulse according to the pixel voltage of the original pixel cell.

In one embodiment, the signal adjustment device is further configured to add a pre-charge pulse before a scanning pulse of the scanning signal when the pixel voltage is lower than the lower limit value of the preset threshold voltage range.

In one embodiment, the pre-charge pulse is configured to pre-charge the original pixel cell within a preset interval time before the scanning pulse.

In one embodiment, the signal adjustment device is further configured to reduce the duty cycle of the high-level pulse in the scanning signal when the pixel voltage is greater than the upper limit value of the preset threshold voltage range.

Another purpose of the present disclosure is providing a display device, including:

a display panel; and

a controller, where the controller is connected with the display panel and comprises a drive system;

the display panel includes 3N scanning lines, N is greater than or equal to 1 and N is a positive integer, and the drive system includes:

a determination device configured to determine whether a pixel voltage of an original pixel cell in the display panel is within a preset threshold voltage range, and further determine whether the pixel voltage is lower than a lower limit value of the preset threshold voltage range or greater than an upper limit value of the preset threshold voltage range; and

a signal adjustment device configured to increase pre-charge time of a scanning signal as output by the scanning line when the pixel voltage is lower than the lower limit value of the preset threshold voltage range, and to reduce the pre-charge time of the scanning signal as output by the scanning line when the pixel voltage is greater than the upper limit value of the preset threshold voltage range.

In one embodiment, the original pixel cell is any one of a red pixel cell, a green pixel cell and a blue pixel cell.

In one embodiment, the display panel comprises an original pixel cell array consisted of rows of pixels and columns of pixels

In one embodiment, the signal adjustment device is further configured to increase a duty cycle of a high-level pulse in the scanning signal when the pixel voltage is lower than the lower limit value of the preset threshold voltage range.

In one embodiment, the signal adjustment device is further configured to add a pre-charge pulse before a scanning pulse of the scanning signal when the pixel voltage is lower than the lower limit value of the preset threshold voltage range.

In one embodiment, the signal adjustment device is further configured to reduce the duty cycle of the high-level pulse in the scanning signal when the pixel voltage is greater than the upper limit value of the preset threshold voltage range.

In the method and system for driving display panel, and display device proposed by the embodiments of the present disclosure, whether the pixel voltage of the original pixel cell in the display panel is within the preset threshold voltage range or not is determined; when the pixel voltage of the original pixel cell in the display panel is within the preset threshold voltage range, the scanning signal as output by the scanning line is not processed; when the pixel voltage of the original pixel cell in the display panel exceeds the preset threshold voltage range, whether the pixel voltage is lower than the lower limit value of the preset threshold voltage range or greater than the upper limit value of the preset threshold voltage value is determined, the pre-charge time in the scanning signal as output by the scanning line is increased when the pixel voltage is lower than the lower limit value of the preset threshold voltage value; the pre-charge time in the scanning signal as output by the scanning line is reduced when the pixel voltage is greater than the upper limit value of the preset threshold voltage value; in this way, a brightness adjustment of the original pixel cell in the display panel is implemented, and the problem that the color cast phenomenon in the display panel may be caused due to the fact that one of the red pixel cell, the green pixel cell and the blue pixel cell is darker, such that the image quality of the display panel is greatly reduced is solved.

### BRIEF DESCRIPTION OF THE DRAWINGS

In order to explain the embodiments of the present disclosure more clearly, a brief introduction regarding the accompanying drawings that need to be used for describing the embodiments is given below; it is obvious that the accompanying drawings described as follows are only some embodiments of the present disclosure, for ordinarily skilled one in the art, other drawings can also be obtained according to the current drawings on the premise of paying no creative labor.

FIG. 1 illustrates a schematic flowchart of a method for driving display panel provided by an embodiment of the present disclosure;

FIG. 2 illustrates a schematic diagram of a driving sequence of scanning signals as output by data signals and scanning lines provided by an embodiment of the present disclosure;

FIG. 3 illustrates waveforms of scanning signals and data signals in another embodiment of the present disclosure;

FIG. 4 illustrates a schematic structural diagram of a drive system of a display panel proposed by an embodiment of the present disclosure; and

FIG. 5 illustrates a modular structure schematic diagram of a display device provided by an embodiment of the present disclosure.

### DESCRIPTION OF THE EMBODIMENTS

In order to make the technical solutions of the present disclosure be more understandable by ordinarily skilled one in the art, the technical solutions in the embodiments of the present disclosure will be described clearly with reference to accompanying drawings in the embodiments; it is obvious that, the embodiments described below are only a part of the embodiments of the present disclosure, but not the entire of the embodiments. Based on the embodiments in the present disclosure, some other embodiments, which are obtained by ordinarily skilled one in the art at the premise of paying no creative labor, should all be included in the protection scope of the present disclosure.

A term “comprise/include” in the description, the claims and the accompanying figures of the present disclosure and their various deformations are intended to cover non-exclusive comprising/including, such as including a process of a list of steps of units, method and system, product and device are not limited to the listed steps or units, however, optionally, the steps or units which are not listed are further included, or optionally, other inherent steps or units for these steps, methods, product and device are further included. Besides, terms including “first”, “second” and “third” are intended to distinguish different objects but not used for describing specific sequences.

The display panel usually needs different supply voltages according to different functions of function modules, and these supply voltages may be provided through a power management chip, in order to avoid too large voltage output signals as output by the power supply management chip, an over-current protection mechanism is arranged in the power supply management chip; for example, a TFT (Thin Film Transistor) liquid crystal display panel requires a plurality of voltage signals, and the voltage values of the plurality of voltage signals are different, in order to provide a plurality of voltage chips for the TFT liquid crystal display panel, a power supply management chip is usually used to provide different voltage output signals; in order to prevent the too large voltage output signal as output by the power supply management chip from over-burning the TFT liquid crystal display panel, the over-current protection mechanism is arranged in the power supply management chip.

At present, LCD (Liquid Crystal Display) is one of the most widely used displays, LCD includes a pair of panels provided with a field generating electrode, and a liquid crystal layer arranged in the two panels, the field generating filed may be such as a pixel electrode and a common electrode and the like, electrode field is generated in the liquid crystal layer by applying a voltage on the field generating electrode, liquid crystal molecules are deflected under the action of the electric field, so that light transmission situation may be controlled and the LCD may be enabled to display images. A tri-gate transistor driving architecture reduces data lines by one third of that of normal driving architecture and increases scanning lines by three times of that of the normal driving architecture, so that data COF (Chip On Film) of a tri-gate driving architecture is reduced by one third of that of the normal driving architecture, and a manufacturing cost of the display panel is greatly saved. In the embodiment of the present disclosure, the display panel includes 3N scanning lines, where N is greater than or equal to 1 and N is a positive integer.

FIG. 1 illustrates a schematic flowchart of a method for driving a display panel according to an embodiment of the present disclosure.

As shown in FIG. 1, the method for driving in the embodiment includes:

determining whether a pixel voltage of an original pixel cell in the display panel is within a preset threshold voltage range or not;

optionally, determining whether the pixel voltage is lower than a lower limit value of the preset threshold voltage range or greater than an upper limit value of the preset threshold voltage range, when the pixel voltage in the original pixel cell is not within the preset threshold voltage range;

optionally, increasing pre-charge time of the scanning signal as output by the scanning line, when the pixel voltage is lower than the lower limit value of the preset threshold voltage range;

optionally, reducing the pre-charge time of the scanning signal as output by the scanning line when the pixel voltage is greater than the upper limit value of the preset threshold voltage range.

The original pixel cell in this embodiment includes any one of a red pixel cell, a green pixel cell and a blue pixel cell, the red pixel cell is configured to emit red light, the green pixel cell is configured to emit green light, and the blue pixel cell is configured to emit blue light, one pixel in the display panel includes a red pixel cell, a green pixel cell and a blue pixel cell, a required color of a user is generated by respectively controlling gray scales of the red pixel cell, the green pixel cell and the blue pixel cell.

In one embodiment, whether a color deviation phenomenon occurs in the display panel is determined by determining whether a pixel voltage of the original pixel cell in the display panel in within the preset threshold voltage range or not; particularly, for example, when a pixel voltage of the blue pixel cell in the display panel is relatively smaller, a lower gray scale of the blue pixel cell may be caused, at this moment, blur color displayed by the blue pixel cell in the display panel is darker, and correspondingly, red color displayed by the red pixel cell and green color displayed by the green pixel cell in the display panel are brighter, such that the whole image displayed by the display panel may be caused to be yellower; when the pixel voltage of the green pixel cell in the display panel is smaller, a lower gray scale of the green pixel cell in the display panel may be caused, at this moment, green color displayed by the green pixel cell in the display panel is darker, and correspondingly, red color displayed by the red pixel cell and blue color displayed by the blue pixel cell in the display panel are brighter, such that the whole image displayed by the display panel may be caused to be more carmine; when the pixel voltage of the red pixel cell in the display panel is smaller, a lower gray scale of the red pixel cell in the display panel may be caused, at this moment, red color displayed by the red pixel in the display panel are darker, and correspondingly, green color displayed by the green pixel cell in the display panel, and blue color displayed by the blue pixel in the display panel are brighter, at this moment, cyan images displayed by the display panel may be caused.

In this embodiment, when the pixel voltage of the original pixel cell in the display panel is within the preset threshold voltage range, whether the display panel generates the color cast phenomenon in the process of image display is determined; particularly, the preset threshold voltage range includes an upper limit value and a lower limit value, if the pixel voltage of the original pixel cell is lower than or equal to the upper limit value, besides, the pixel voltage of the original pixel cell is greater than or equal to the lower limit value, the corresponding primary color is determined to be normally displayed by the original pixel cell, images of the display panel are displayed normally, at this moment, a scanning signal as output by the scanning line is output normally, and signals on the scanning line are not adjusted.

In one embodiment, when the pixel voltage of the original pixel cell in the display panel exceeds the preset threshold voltage range, whether the pixel voltage is lower than the lower limit value of the preset threshold voltage range or greater than the upper limit value of the preset threshold voltage range is determined; particularly, when is lower than the lower limit value of the voltage range of the preset threshold value, a generation of color cast phenomenon of the display panel may be caused; when the pixel voltage is greater than the upper limit value of the preset threshold voltage range, too large voltages of pixels may be caused due to the fact that charging time of the original pixel cell in the display panel is too long, so that the display panel is burnt out.

In one embodiment, the pre-charge time of the scanning signal as output by the scanning line is increased when the pixel voltage of the original pixel in the display panel is detected to be lower than the lower limit value of the preset threshold voltage range, so that the pixel voltage of the original pixel cell is increased, at this moment, the gray scale of the original pixel cell is increased, and the brightness of the original color displayed by the corresponding original pixel cell in the display panel is increased, too. The pre-charge time in the scanning signal as output by the scanning line is reduced when the pixel voltage of the original pixel cell is greater than the upper limit value of the preset threshold voltage range, the pre-charging time of the scanning signal as output by the scanning line is reduced, so that the pre-charging time is reduced, the pixel voltage of the original pixel cell is reduced, and the display panel is prevented from being burned out due to too high pixel voltage of the original pixel cell.

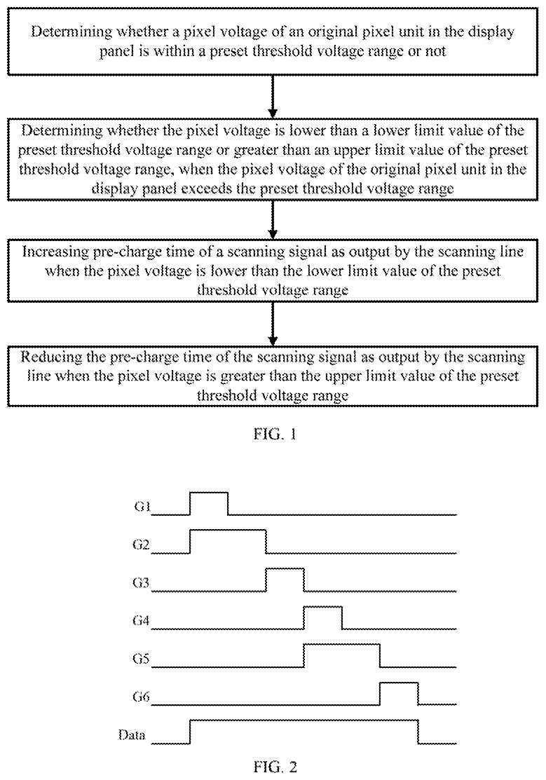

FIG. 2 illustrates a schematic diagram of a driving sequence of a scanning signal as output by a data signal and a scanning line according to one embodiment of the present disclosure.

As shown in FIG. 2, said increasing pre-charge time in the scanning signal as output by the scanning line includes: increasing a duty cycle of a high-level pulse in the scanning signal.

In this embodiment, the charging time of the original pixel cell is increased by increasing a total of duty cycles of the high-level pulse in the scanning signal as output by the scanning line in the display panel, that is, the duty cycle of the high-level pulse is increased based on the original scanning pulse, a pixel charging rate of the original pixel cell is improved according to this pre-charging mode, so that the primary color of the original pixel cell is brighter, and An object of improving color deviation of the display panel is achieved.

In one embodiment, the duty cycle of the high level pulse in the scanning signal may be detected according to a detected voltage value of the pixel voltage of the original pixel cell, the lower the detected pixel voltage of the original pixel cell is, the higher the duty cycle of the high-level pulse in the scanning signal is. In FIG. 2, G1, G2, G3, G4, G5 and G6 are scanning lines of two rows of pixels respectively, where G1, G2 and G3 are scanning lines of the red pixel cell, the green pixel cell and the blue pixel cell in the first group of pixels respectively, G4, G5 and G6 are scanning lines of the red pixel cell, the green pixel cell and the blue pixel cell in the second set of pixels respectively, data is a waveform of a data signal in the display panel; as shown in FIG. 2, when the pixel voltage of the green pixel cell is lower than the lower limit value of the preset threshold voltage range, a total of duty cycles of the high-level pulse in the scanning signal as output by the scanning line of the green pixel cell is adjusted, such that the pre-charge time of the green pixel cell in the display panel may be improved, and green color displayed by the green pixel cell in the display panel may be brighter.

In one embodiment, said increasing pre-charge time of the scanning signal as output by the scanning line includes: adding a pre-charge pulse before the scanning pulse in the scanning signal.

In this embodiment, the pre-charge pulse is added before the scanning pulse in the original scanning signal, such that the original pixel cell may be charged before the corresponding original pixel cell is opened by the pulse in the scanning signal, and the pixel charging rate of the original pixel cell is improved; when the scanning pulse reaches the original pixel cell, the original pixel cell is formally charged in order that the original pixel cell is opened to display the corresponding color brightness.

In one embodiment, the pre-charge pulse is configured to charge the original pixel cell in a preset interval time before the scanning pulse.

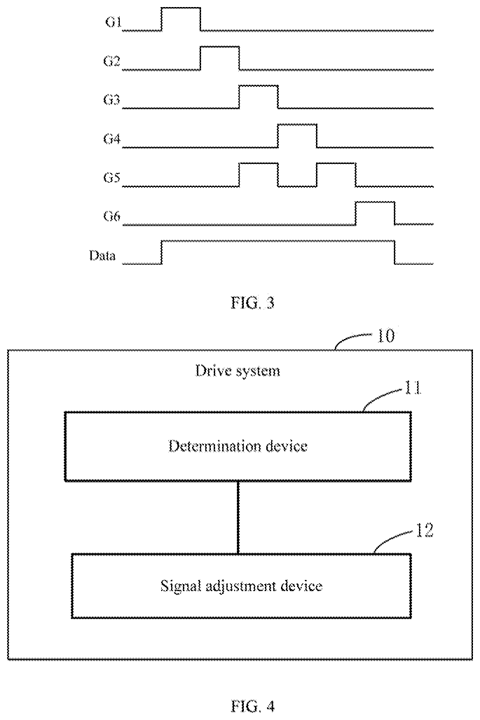

FIG. 3 illustrates a waveform diagram of the scanning signal and the data signal in another embodiment of the present disclosure.

In one embodiment, FIG. 3 illustrates a schematic diagram of arranging the pre-charge pulse ahead of a preset time interval before the scanning line as output by the scanning line corresponding to the green pixel cell, when the pixel voltage of the green pixel cell is lower than the lower limit value of the preset threshold voltage range, as shown in FIG. 3, the pre-charge pulse pre-charges the green pixel cell ahead of the preset time interval so as to improve the pixel charging rate of the green pixel cell, the green pixel cell is charged formally when the scanning pulse reaches the green pixel cell.

In one embodiment, said reducing the pre-charge time in the scanning signal includes: reducing the duty cycle of the high-level pulse in the scanning signal.

In this embodiment, when the pixel voltage of the original pixel in the display panel is detected to be greater than the upper limit value of the preset threshold voltage range, the pre-charge time of the original pixel cell is reduced by reducing the total of duty cycles of the high-level pulse in the scanning signal and reducing scanning signals as output by the corresponding scanning line.

The steps in the method of the embodiment of the present disclosure may be sequentially adjusted, combined and deleted according to actual need.

Ordinarily skilled one in the art can understand that a whole or part of flow process of implementing the method in the aforesaid embodiments of the present disclosure may be accomplished by using computer program to instruct relevant hardware. When the computer program is executed by the processor, the steps in the various method embodiments described above can be implemented. Where, the storage medium may be a magnetic disk, an optical disk, a ROM (Read-only Memory) or RAM (Random Access Memory), or the like.

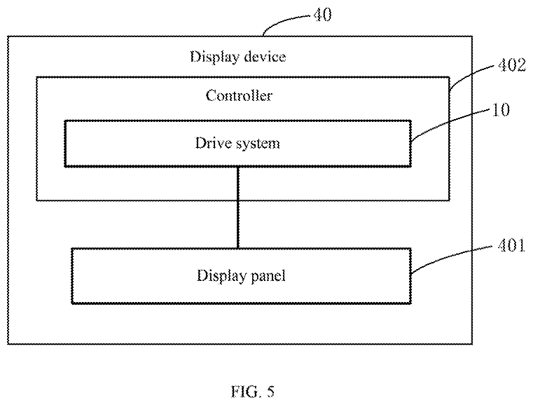

FIG. 4 illustrates a schematic structural diagram of a system for driving a display panel according to an embodiment of the present disclosure.

The display panel includes 3N scanning lines, N is greater than or equal to 1 and N is a positive integer; the system 10 for driving display panel includes:

a determination device 11 configured to determine whether a pixel voltage of an original pixel cell in the display panel is within a preset threshold voltage range, and further determine whether the pixel voltage is lower than a lower limit value of the preset threshold voltage range or greater than an upper limit value of the preset threshold voltage range; where the original pixel cell is any one of a red pixel cell, a green pixel cell and a blue pixel cell; and

a signal adjustment device 12 configured to increase pre-charge time of a scanning signal as output by the scanning line when the pixel voltage is lower than the lower limit value of the preset threshold voltage range, and reduce the pre-charge time of the scanning signal as output by the scanning line when the pixel voltage is greater than the upper limit value of the preset threshold voltage range.

The original pixel cell in this embodiment includes any one of a red pixel cell, a green pixel cell and a blue pixel cell, the red pixel cell is configured to emit red light, the green pixel cell is configured to emit green light, and the blue pixel cell is configured to emit blue light, one pixel in the display panel includes a red pixel cell, a green pixel cell and a blue pixel cell, a required color of a user is generated by respectively controlling gray scales of the red pixel cell, the green pixel cell and the blue pixel cell. In the embodiment, the determination device 11 is configured to determine whether pixel voltage of the original pixel in the display panel is within the preset threshold voltage range, and further determine whether a color cast phenomenon occurs in the display panel.

Particularly, for example, when the determination device 11 detects that a pixel voltage of the blue pixel cell in the display panel is relatively lower, a lower gray scale of the blue pixel cell may be caused, at this moment, blur color displayed by the blue pixel cell in the display panel is darker, and correspondingly, red color displayed by the red pixel cell and green color displayed by the green pixel cell in the display panel are brighter, such that the whole image displayed by the display panel is caused to be yellower; when the determination device 11 detects that the pixel voltage of the green pixel cell in the display panel is smaller, a lower gray scale of the green pixel cell in the display panel may be caused, at this moment, green color displayed by the green pixel cell in the display panel is darker, and correspondingly, red color displayed by the red pixel cell and blue color displayed by the blue pixel cell in the display panel are brighter, such that the whole image displayed by the display panel may be caused to be more carmine; when the determination device 11 detects that the pixel voltage of the red pixel cell in the display panel is smaller, a lower gray scale of the red pixel cell in the display panel may be caused, at this moment, red color displayed by the red pixel in the display panel are darker, and correspondingly, green color displayed by the green pixel cell and blue color displayed by the blue pixel in the display panel are brighter, at this moment, cyan images displayed by the display panel may be caused.

In this embodiment, when the pixel voltage of the original pixel cell in the display panel is detected to be within the preset threshold voltage range, the determination device 11 determines whether the display panel generates the color cast phenomenon in an image displaying process; particularly, the preset threshold voltage range includes an upper limit value and a lower limit value, if the pixel voltage of the original pixel cell is lower than or equal to the upper limit value, besides, the pixel voltage of the original pixel cell is greater than or equal to the lower limit value, the corresponding primary color is determined to be normally displayed by the original pixel cell, images of the display panel are displayed normally; at this moment, a scanning signal as output by the scanning line is output normally, and signals on the scanning line are not adjusted.

When the pixel voltage of the original pixel cell in the display panel exceeds the preset threshold voltage range, whether the pixel voltage is lower than the lower limit value of the preset threshold voltage range or greater than the upper limit value of the preset threshold voltage range is determined; particularly, when is lower than the lower limit value of the voltage range of the preset threshold value, a generation of color cast phenomenon of the display panel may be caused; when the pixel voltage is greater than the upper limit value of the preset threshold voltage range, too large voltages of pixels may be caused due to the fact that charging time of the original pixel cell in the display panel is too long, so that the display panel is burnt out.

In one embodiment, the signal adjustment device 12 is configured to increase the pre-charge time of the scanning signal as output by the scanning line to increase the pixel voltage of the original pixel cell, when the pixel voltage of the original pixel in the display panel is detected to be lower than the lower limit value of the preset threshold voltage range; at this moment, the gray scale of the original pixel cell is increased, and the brightness of the original color displayed by the corresponding original pixel cell in the display panel is increased, too. The signal adjustment device 12 is configured to reduce the pre-charge time in the scanning signal as output by the scanning line when the pixel voltage of the original pixel cell is greater than the upper limit value of the preset threshold voltage range, the pre-charging time of the scanning signal as output by the scanning line is reduced, so that the pre-charging time is reduced, the pixel voltage of the original pixel cell is reduced, and the display panel is prevented from being burned out due to too high pixel voltage of the original pixel cell.

In one embodiment, the signal adjustment device 12 is further configured to increase the duty cycle of the high-level pulse in the scanning signal when the pixel voltage is lower than the lower limit value of the preset threshold voltage range.

In one embodiment, the signal adjustment device 12 is further configured to add a pre-charge pulse before the scanning pulse in the scanning signal when the pixel voltage is lower than the lower limit value of the preset threshold voltage range.

In this embodiment, the pre-charge pulse is added by the signal adjustment device 12 before the scanning pulse in the original scanning signal, such that the original pixel cell may be charged before the corresponding original pixel cell is opened by the pulse in the scanning signal, and the pixel charging rate of the original pixel cell is improved; when the scanning pulse reaches the original pixel cell, the original pixel cell is charged formally, so that the original pixel cell is opened to display the corresponding color brightness.

In one embodiment, the signal adjustment device 12 is further configured to control the pre-charge pulse to charge the original pixel cell within a preset interval time before the scanning pulse.

In one embodiment, the signal adjustment device 12 is further configured to reduce the duty cycle of the high-level pulse in the scanning signal as output by the scanning line, when the pixel voltage is greater than the upper limit value of the preset threshold voltage range.

In the embodiment, when the determination device 11 detects that the pixel voltage of the original pixel in the display panel is greater than the upper limit value of the preset threshold voltage range, the pre-charge time of the original pixel cell is reduced by reducing the total of duty cycles of the high-level pulse in the scanning signal and reducing scanning signals as output by the corresponding scanning line.

In a specific application, the display panel may be any type of display panel, such as a liquid crystal display panel based on TFT-LCD (Thin Film Transistor Liquid Crystal Display) technology, a liquid crystal display panel based on LCD (Liquid Crystal Display), an organic electroluminensence display panel based on OLED technology, QLED (Quantum Dot Light Emitting Diode) display panel based on QLED technology, a curved surface display panel and the like.

The modules in all embodiments of the present disclosure may be realized by a general-purpose IC (Integrated Circuit) such as CPU (Central Processing Unit), or by ASIC (Application Specific Integrated Circuit).

FIG. 5 illustrates a modular structure schematic diagram of a display device provided by an embodiment of the present disclosure.

As shown in FIG. 5, one embodiment of the present disclosure further provides a display device 50 which includes a display panel 401 and a controller 402, wherein the controller 402 includes the system 10 for driving display panel in the aforesaid embodiment.

The display panel includes 3N scanning lines, N is greater than or equal to 1 and N is a positive integer; the system 10 for driving display panel includes:

a determination device 11 configured to determine whether a pixel voltage of an original pixel cell in the display panel is within a preset threshold voltage range, and further determine whether the pixel voltage is lower than a lower limit value of the preset threshold voltage range or greater than an upper limit value of the preset threshold voltage range; where the original pixel cell is any one of a red pixel cell, a green pixel cell and a blue pixel cell; and

a signal adjustment device 12 configured to increase pre-charge time of a scanning signal as output by the scanning line when the pixel voltage is lower than the lower limit value of the preset threshold voltage range, and reduce the pre-charge time of the scanning signal as output by the scanning line when the pixel voltage is greater than the upper limit value of the preset threshold voltage range.

The original pixel cell in this embodiment includes any one of a red pixel cell, a green pixel cell and a blue pixel cell, the red pixel cell is configured to emit red light, the green pixel cell is configured to emit green light, and the blue pixel cell is configured to emit blue light, one pixel in the display panel includes a red pixel cell, a green pixel cell and a blue pixel cell, a required color of a user is generated by respectively controlling gray scales of the red pixel cell, the green pixel cell and the blue pixel cell. In the embodiment, the determination device 11 is configured to determine whether pixel voltage of the original pixel in the display panel is within the preset threshold voltage range, and further determine whether a color cast phenomenon occurs in the display panel.

Particularly, for example, when the determination device 11 detects that a pixel voltage of the blue pixel cell in the display panel is relatively smaller, a lower gray scale of the blue pixel cell may be caused, at this moment, blur color displayed by the blue pixel cell in the display panel is darker, and correspondingly, red color displayed by the red pixel cell and green color displayed by the green pixel cell in the display panel are brighter, and the whole image displayed by the display panel is caused to be yellower; when the determination device 11 detects that the pixel voltage of the green pixel cell in the display panel is smaller, a lower gray scale of the green pixel cell in the display panel may be caused, at this moment, green color displayed by the green pixel cell in the display panel is darker, and correspondingly, red color displayed by the red pixel cell and blue color displayed by the blue pixel cell in the display panel are brighter, such that the whole image displayed by the display panel may be caused to be more carmine; when the determination device 11 detects that the pixel voltage of the red pixel cell in the display panel is lower, a lower gray scale of the red pixel cell in the display panel may be caused, at this moment, red color displayed by the red pixel in the display panel are darker, and correspondingly, green color displayed by the green pixel cell and blue color displayed by the blue pixel in the display panel are brighter, at this moment, cyan images displayed by the display panel may be caused.

In this embodiment, when the pixel voltage of the original pixel cell in the display panel is detected to be within the preset threshold voltage range, the determination device 11 determines whether the display panel generates the color cast phenomenon in an image displaying process; particularly, the preset threshold voltage range includes an upper limit value and a lower limit value, when the pixel voltage of the original pixel cell is lower than or equal to the upper limit value, besides, the pixel voltage of the original pixel cell is greater than or equal to the lower limit value, the corresponding primary color is determined to be normally displayed by the original pixel cell, images of the display panel are displayed normally; at this moment, a scanning signal as output by the scanning line is output normally, and signals on the scanning line are not adjusted.

When the pixel voltage of the original pixel cell in the display panel exceeds the preset threshold voltage range, whether the pixel voltage is lower than the lower limit value of the preset threshold voltage range or greater than the upper limit value of the preset threshold voltage range is determined; particularly, when is lower than the lower limit value of the voltage range of the preset threshold value, a generation of color cast phenomenon of the display panel may be caused; when the pixel voltage is greater than the upper limit value of the preset threshold voltage range, too large voltages of pixels may be caused due to the fact that charging time of the original pixel cell in the display panel is too long, so that the display panel is burnt out.

In one embodiment, the signal adjustment device 12 is configured to increase the pre-charge time of the scanning signal as output by the scanning line to increase the pixel voltage of the original pixel cell, when the pixel voltage of the original pixel in the display panel is detected to be lower than the lower limit value of the preset threshold voltage range; at this moment, the gray scale of the original pixel cell is increased, and the brightness of the original color displayed by the corresponding original pixel cell in the display panel is increased, too. The signal adjustment device 12 is configured to reduce the pre-charge time in the scanning signal as output by the scanning line when the pixel voltage of the original pixel cell is greater than the upper limit value of the preset threshold voltage range, the pre-charging time of the scanning signal as output by the scanning line is reduced, so that the pre-charging time is reduced, the pixel voltage of the original pixel cell is reduced, and the display panel is prevented from being burned out due to too high pixel voltage of the original pixel cell.

In one embodiment, the signal adjustment device 12 is further configured to increase the duty cycle of the high-level pulse in the scanning signal when the pixel voltage is lower than the lower limit value of the preset threshold voltage range.

In one embodiment, the signal adjustment device 12 is further configured to add a pre-charge pulse before the scanning pulse in the scanning signal when the pixel voltage is lower than the lower limit value of the preset threshold voltage range.

In this embodiment, the pre-charge pulse is added by the signal adjustment device 12 before the scanning pulse in the original scanning signal, such that the original pixel cell may be charged before the corresponding original pixel cell is opened by the pulse in the scanning signal, and the pixel charging rate of the original pixel cell is improved; when the scanning pulse reaches the original pixel cell, the original pixel cell is formally charged, so that the original pixel cell is opened to display the corresponding color brightness.

In one embodiment, the signal adjustment device 12 is further configured to control the pre-charge pulse to charge the original pixel cell within a preset interval time before the scanning pulse.

In one embodiment, the signal adjustment device 12 is further configured to reduce the duty cycle of the high-level pulse in the scanning signal as output by the scanning line, when the pixel voltage is greater than the upper limit value of the preset threshold voltage range.

In the embodiment, when the determination device 11 detects that the pixel voltage of the original pixel in the display panel is greater than the upper limit value of the preset threshold voltage range, the pre-charge time of the original pixel cell is reduced by reducing the total of duty cycles of the high-level pulse in the scanning signal and reducing scanning signals as output by the corresponding scanning line.

In a specific application, the display panel 40 may be any type of display panel which is provided with the system 10 for driving display panel, such as a liquid crystal display panel, an OLED (Organic Light Emitting Diode) display device, a QLED (Quantum Dot Light Emitting Diode) display device, or a curved surface display device or the like.

In one embodiment, the display panel 401 includes an original pixel cell array consisted of rows of pixels and columns of pixels.

In one embodiment, the original pixel cell is any one of the red pixel cell, the green pixel cell and the blue pixel cell.

In one embodiment, the display panel 401 includes an original pixel cell array consisted of rows of pixels and columns of pixels.

In one embodiment, the signal adjustment device 12 is further configured to increase the duty cycle of the high-level pulse in the scanning signal, when the pixel voltage is lower than the lower limit value of the preset threshold voltage range.

In one embodiment, the signal adjustment device 12 is further configured to add a pre-charge pulse before the scanning pulse in the scanning signal, when the pixel voltage is lower than the lower limit value of the preset threshold voltage range.

In one embodiment, the signal adjustment device 12 is further configured to reduce the duty cycle of the high-level pulse in the scanning signal as output by the scanning line, when the pixel voltage is greater than the upper limit value of the preset threshold voltage range.

In one embodiment, the controller 402 may be realized by a general-purpose IC (Integrated Circuit) such as CPU (Central Processing Unit), or by ASIC (Application Specific Integrated Circuit).

The aforementioned embodiments are only preferable embodiments of the present disclosure, and should not be regarded as being limitation to the present disclosure. Any modification, equivalent replacement, improvement, and so on, which are made within the spirit and the principle of the present disclosure, should be included in the protection scope of the present disclosure.

What is claimed is:

1. A method for driving display panel, wherein the display panel comprises 3N scanning lines, wherein N is greater than or equal to 1, and N is a positive integer, the method comprising:
determining whether a pixel voltage of an original pixel cell in the display panel is within a preset threshold voltage range or not;
determining whether the pixel voltage is lower than a lower limit value of the preset threshold voltage range or greater than an upper limit value of the preset threshold voltage range, when the pixel voltage of the original pixel cell in the display panel exceeds the preset threshold voltage range;
increasing pre-charge time of a scanning signal as output by the scanning line when the pixel voltage is lower than the lower limit value of the preset threshold voltage range;
reducing the pre-charge time of the scanning signal as output by the scanning line when the pixel voltage is greater than the upper limit value of the preset threshold voltage range.

2. The method for driving display panel according to claim 1, wherein the original pixel cell is any one of a red pixel cell, a green pixel cell and a blue pixel cell.

3. The driving method according to claim 1, said increasing pre-charging time of a scanning signal as output by the scanning line comprises:
increasing a duty cycle of a high-level pulse in the scanning signal.

4. The method for driving display panel according to claim 3, wherein said increasing a duty cycle of a high-level pulse in the scanning signal comprises:
determining the duty cycle of the high-level pulse according to the pixel voltage of the original pixel cell.

5. The method for driving display panel according to claim 1, said increasing pre-charge time of a scanning signal as output by the scanning line comprises:
adding a pre-charge pulse before a scanning pulse of the scanning signal.

6. The method for driving display panel according to claim 5, wherein the pre-charge pulse is configured to pre-charge the original pixel cell within a preset interval time before the scanning pulse.

7. The method for driving display panel according to claim 1, wherein said reducing the pre-charge time of the scanning signal comprises:
reducing the duty cycle of the high-level pulse in the scanning signal.

8. A system for driving display panel, wherein the display panel comprises 3N scanning lines, N is greater than or equal to 1 and N is a positive integer, and the system for driving display panel comprises:
a determination device configured to determine whether a pixel voltage of an original pixel cell in the display panel is within a preset threshold voltage range, and further determine whether the pixel voltage is lower than a lower limit value of the preset threshold voltage range or greater than an upper limit value of the preset threshold voltage range; and
a signal adjustment device configured to increase pre-charge time of a scanning signal as output by the scanning line when the pixel voltage is lower than the lower limit value of the preset threshold voltage range, and reduce the pre-charge time of the scanning signal as output by the scanning line when the pixel voltage is greater than the upper limit value of the preset threshold voltage range.

9. The system for driving display panel according to claim 8, wherein the original pixel cell is any one of a red pixel cell, a green pixel cell and a blue pixel cell.

10. The system for driving display panel according to claim 8, wherein the signal adjustment device is further configured to increase a duty cycle of a high-level pulse in the scanning signal when the pixel voltage is lower than the lower limit value of the preset threshold voltage range.

11. The system for driving display panel according to claim 10, wherein the signal adjustment device is further configured to determine the duty cycle of the high-level pulse according to the pixel voltage of the original pixel cell.

12. The system for driving display panel according to claim 8, wherein the signal adjustment device is further configured to add a pre-charge pulse before a scanning pulse of the scanning signal when the pixel voltage is lower than the lower limit value of the preset threshold voltage range.

13. The system for driving display panel according to claim 12, wherein the pre-charge pulse is configured to pre-charge the original pixel cell within a preset interval time before the scanning pulse.

14. The system for driving display panel according to claim 8, wherein the signal adjustment device is further configured to reduce the duty cycle of the high-level pulse in the scanning signal when the pixel voltage is greater than the upper limit value of the preset threshold voltage range.

15. A display device, comprising:
a display panel; and
a controller, wherein the controller is connected with the display panel and comprises a drive system;
wherein the display panel comprises 3N scanning lines, N is greater than or equal to 1 and N is a positive integer, and the drive system comprises:
a determination device configured to determine whether a pixel voltage of an original pixel cell in the display panel is within a preset threshold voltage range, and further determine whether the pixel voltage is lower than a lower limit value of the preset threshold voltage range or greater than an upper limit value of the preset threshold voltage range; and
a signal adjustment device configured to increase pre-charge time of a scanning signal as output by the scanning line when the pixel voltage is lower than the lower limit value of the preset threshold voltage range, and to reduce the pre-charge time of the scanning signal as output by the scanning line when the pixel voltage is greater than the upper limit value of the preset threshold voltage range.

16. The display device according to claim 15, wherein the original pixel cell is any one of a red pixel cell, a green pixel cell and a blue pixel cell.

17. The display device according to claim 15, wherein the display panel comprises an original pixel cell array consisted of rows of pixels and columns of pixels

18. The display device according to claim 15, wherein the signal adjustment device is further configured to increase a duty cycle of a high-level pulse in the scanning signal when the pixel voltage is lower than the lower limit value of the preset threshold voltage range.

19. The display device according to claim 15, wherein the signal adjustment device is further configured to add a pre-charge pulse before a scanning pulse of the scanning signal when the pixel voltage is lower than the lower limit value of the preset threshold voltage range.

20. The display device according to claim 15, wherein the signal adjustment device is further configured to reduce the duty cycle of the high-level pulse in the scanning signal when the pixel voltage is greater than the upper limit value of the preset threshold voltage range.
